(19) United States
(12) Patent Application Publication
(10) Pub. No.: US 2008/0140715 A1
(43) Pub. Date: Jun. 12, 2008

(54) Method and Apparatus for Tracking the Distribution of Pharmaceutical Products

(76) Inventor: George Hakos, New South Wales (AU)

Correspondence Address: NATH & ASSOCIATES, 112 South West Street, Alexandria, VA, 22314, US

(21) Appl. No.: 11/883,840

(22) PCT Filed: Feb. 7, 2006
(86) PCT No.: PCT/AU06/00151

§ 371 Date: Oct. 24, 2007

Related U.S. Application Data
(60) Provisional application No. 60/660,861, filed on Mar. 10, 2005.

(30) Foreign Application Priority Data
Feb. 8, 2005 (AU) 2005900549

(51) Int. Cl. G06F 17/00

(52) U.S. Cl. 707/104.1

(57) ABSTRACT

A method for use in tracking the transaction of pharmaceutical-related products from a supplier to a receiver, said method being operable on a computer system including a first server interconnected to a relatively remote second server via a communication link, wherein said method includes the steps of: (i) inputting transaction information into the second server, said transaction information including electronically encoded data representing a unique signature of the receiver for verifying the identity of the receiver; (ii) transmitting the transaction information from the second server to the first server via the communication link; (iii) storing the transaction information received by the first server in a database of the first server; (iv) generating a report based on the transaction information stored in the database.

### TECHNICAL FIELD

The present invention relates to a method and apparatus for tracking and/or verifying information relating to the distribution of pharmaceutical related products, and in particular, related to the distribution of pharmaceutical and related sample products supplied to Doctors (including medical practitioners, dentists and veterinarians) by Pharmaceutical companies, and, in the generation of reports based on the tracked distribution data.

### BACKGROUND OF THE INVENTION

The reference to any prior art in this specification is not, and should not be taken as, an acknowledgment or any form of suggestion that that prior art forms part of the common general knowledge.

Pharmaceutical companies have traditionally employed sales representatives to market and distribute drug samples to medical practitioners with the expectation that the medical practitioners will provide support by prescribing and recommending the company's products to their patients.

In the course of distributing the drug samples sales representatives are required to, in adherence to governmental regulations or otherwise, maintain a record of the drugs which have been distributed. For instance, a sales representative will typically be in possession of a “sample book” in which details of all drug transactions are entered in to it. These details may include such things as the name of the medical practitioner in question, the medical practitioner's address, the name of the drug sample, the number of samples distributed, and the date of the distribution. The medical practitioner will also be required to sign the sample book entry in order to verify that he/she has received the drug samples from the representative. Thereafter, the “sample books” are manually submitted to the pharmaceutical administrators for filing.

The information contained in the filed “sample books” is generally accessed whenever an audit is conducted, or, possibly when a product recall is to be effected.

A number of problems are perceived to exist in respect of the present system described above. Firstly, the manual entry of drug distribution details in to the sample books tends to be inaccurate due to the method of entry and also due to the lack of signature verification.

The task of accessing information contained within the stored sample books at the time of an audit or product recall is equally time-consuming and tedious to complete. Also, it is not uncommon for errors to occur due to the manual entry of details into the “sample books” due to human error.

For example, if a recall of a pharmaceutical product occurred, it would take a considerable amount of time (e.g weeks or months) to accurately determine recipients of the recalled pharmaceutical product. Equally important, if an audit was to be performed by a Health Department, there would be no way for the Health Department to easily determine if the signature in the sample book was authentic.

A further problem associated with the above-mentioned system is that the process of recording drug distribution information lacks sufficient accountability. For instance, as many sales representative jobs are commission or quota based, there may be an incentive for dishonest sales representatives to enter bogus details in a sample book to present the appearance that he/she has legitimately distributed drug samples to a large number of medical practitioners. This may involve the sales representative having to forge a doctor's signature in a sample book or ask a secretary to sign instead. However, as there is very little accountability in terms of verifying the signatures entered into the sample books, dishonest sales representatives will more often than not go undetected. Currently, no system or process is in place to determine and verify the authenticity of the Doctors' signature on the sample book.

As a consequence of the above-stated problems, human lives may be unduly placed at risk due to the introduction of inaccurate information, inadvertently or otherwise, for example, if a drug recall was performed.

Yet a further problem encountered in the present system is that it is difficult for managers to keep track of the work patterns of their sales representatives. Currently, representatives are trusted to enter the correct name, date and amount of drug samples given. Furthermore, there is no time stamp entered in the sample book to indicate when the transaction occurred, nor is a schedule (S2,S3,S4 or S8), batch number, or, expiry date of the sample drug routinely written in the sample book.

The ability to monitor and track such work behaviour would provide useful information to company managers and the like with which to better utilise human resources within the company, and, to identify and address weaknesses within the work force. A better system of monitoring work patterns amongst sales representatives would clearly provide the company with a commercial edge over the competition and more importantly, a more accurate and reliable recording system.

### SUMMARY OF THE INVENTION

The present invention seeks to alleviate at least one of the problems discussed above.

The present invention involves several different broad forms. Embodiments of the invention may include one or any combination of the different broad forms herein described.

In a first broad form, the present invention provides a method for use in tracking the transaction of pharmaceutical-related products from a supplier to a receiver, said method being operable on a computer system including a first server interconnected to a relatively remote second server via a communication link, wherein said method includes the steps of:
(i) inputting transaction information into the second server, said transaction information including electronically encoded data representing a unique signature of the receiver for verifying the identity of the receiver;
(ii) transmitting the transaction information from the second server to the first server via the communication link;
(iii) storing the transaction information received by the first server in a database of the first server;
(iv) generating at least one report based on the transaction information stored in the database.

Typically, the term “supplier” may include a sales representative either employed or contracted by a pharmaceutical company to supply pharmaceutical products to a receiving party. Typically, the “receiver may include a “medical practitioner”, “pharmacist” or the like who may be supplied pharmaceutical products from a pharmaceutical supplier.

Preferably, the term “pharmaceutical-related product” may include not only drug samples and other therapeutic goods, but also, promotional materials which may relate to such drug samples and/or therapeutic goods.

Preferably, the first server may be interconnected to a plurality of second servers via the communication link. Typically, the communication link may include the Internet, a Wide-Area-Network, a Local-Area-Network, or any other suitable telecommunications channel capable of accommodating voice and/or data transmission. For instance, the second server may include a mobile computing device which uses a PCMCIA card to facilitate transmission of data between the first and second servers.

Preferably, the first server includes a central computer including a database. The database may include a relational database wherein data stored in the database may be manipulated using a query language or the like.

Typically, the second server includes a portable computing device such as a PDA, a laptop computer, a mobile phone or the like.

Preferably, the transaction information may also include at least one of the following details of the transaction:
(a) data representing an identity of the receiver;
(b) data representing an identity of the supplier;
(c) data representing an identity of the product being distributed;
(d) data representing a quantity of the product being distributed;
(e) data representing a time and/or date at which the product is distributed; data representing a location where the distribution takes place;
(f) data representing a location where the distribution takes place.

Typically, the signature of the receiver includes a hand-written signature encoded in electronic format. Alternatively, the signature may include a unique code, or, unique biometric characteristic of the receiver who receives for instance a drug sample.

Preferably, the step of inputting transaction information into the second server includes the use of at least one of:
a keypad; and
a scanner such as a bar-code scanner,
a touch-screen display.

It would be appreciated by a person skilled in the art that various aspects of the transaction information for a given transaction may lend itself to being entered into the second server in a particular way.

For instance, the signature of the party which receives the pharmaceutical product sample, may typically be signed directly on to the touch-screen display. Alternatively, the receiving party may manually sign his or her signature on to a non-electronic writing surface, and thereafter, a scanner is used to scan the written signature into the second server. Typically, the scanner may be integrated into the second server.

Alternatively, where the receiver's signature consists of a unique biometric characteristic, a biometric scanner may be employed to scan the unique biometric characteristic of the receiving party such as, but not limited to:
(a) a finger/thumb print; or
(b) an iris/retina scanner.

Aspects of the transaction information relating for instance to the nature and identity of product itself are typically printed on the product in alphanumeric indicia, and/or encoded in bar-code format. Such transaction information may include information relating to the identity of the product being distributed, batch number, name of the product, the class and schedule of drug and the identity of the product manufacturer and so on. Advantageously, a bar-code scanner may be used to conveniently scan the bar-code when this aspect of the transaction information is to be input into the second server. Of course, this type of transaction information may be entered manually into the second server via the keypad if desired.

Transaction information relating to the time and date of a given transaction may generally be input into the second server automatically by reference to a clock of the second server. Typically, the second server may be adapted to communicate with a Global Position System (GPS) communication network, and, the second server clock may be synchronised with a clock of the GPS system. Typically, the second server clock and the GPS clock may be periodically synchronised—for instance, at 5 second intervals. Advantageously, where multiple second servers are concerned, the ability to synchronise them with a common clock may be advantageous in maintaining a common time reference.

Typically, the time and date stamp relating to any given transaction may be automatically generated and included in the transaction information when the user activates a control switch located on the second server.

Preferably, the data representing the location of the transaction may also be generated by reference to the GPS network. For instance, this may include a set of coordinates generated by the GPS network which are communicated to the second server. Such information may also be automatically integrated into the transaction information.

Preferably, the transaction information may be transmitted from the second server to the first server via at least one of the following communication medium:
(a) E-mail;
(b) facsimile;
(c) Short-Message-Service;
(d) GPRS.

Preferably, the transaction information may be encrypted prior to transmission from the second server, and, decrypted after being received by the first server. For instance, various encryption protocols may be used in combination.

Preferably, the present invention includes a step of verifying an authenticity of the received signature data. For instance, this may involve the step of performing a correlation of the received signature with a pre-recorded sample of the receiver's signature. Typically, signature verification may be effected using software. Preferably, the present invention includes a further step of generating a notification where a signature is not verified. Advantageously, this may assist in ensuring that transaction information that is stored into the database for processing is reliable and accurate. It may also assist in alleviating the ability of dishonest sales representatives from recording bogus drug sample transactions.

Typically, the report that is generated from recorded transaction information may include statistical and/or demographical information relating to the distribution of products distributed from suppliers to receivers. The report may also include information relating to the specific work patterns of sales representatives. Preferably, the report that is generated may include statistical and/or demographical reflecting the status of pharmaceutical drug sample distribution behaviour in respect of a specific daily, weekly, monthly and/or yearly timeframe.

Preferably, the report may be automatically communicated from the first server to a predetermined third party. Generally, this may occur on a daily, weekly, monthly and/or yearly basis. Typically, the report may be communicated to the third party via at least one of:
(a) E-mail;
(b) Facsimile;
(c) Short-Message-Service;
(d) Printed message utilising conventional mailing system;
(e) GPRS; or
(f) a Web page accessible via the Internet. Typically the report may be provided via a secure Internet Web site.

In a second broad form, the present invention includes a computer system programmed to perform the method steps in accordance with the first broad form of the present invention.

In a third broad form, the present invention provides a computer-readable medium having computer-executable instructions for performing the method steps in accordance with the first broad form of the present invention.

In a fourth broad form, the present invention provides a computer-readable medium having stored thereon a data structure produced in accordance with method steps of the first broad form of the present invention.

In a fifth broad form, the present invention provides, in combination with a computer system, a graphical-user interface including a display and a selection device, a method of providing and selecting from a menu on the display, the method steps of the first broad form of the present invention.

In a sixth broad form, the present invention provides a report generated in accordance with the method of first broad form.

### BRIEF DESCRIPTION OF THE DRAWINGS

The present invention will become more fully understood from the following detailed description of a preferred but non-limiting embodiment thereof, described in connection with the accompanying drawings, wherein:

FIG. 1 shows a block diagram of a system in accordance with a first embodiment of the present invention;

FIG. 2 shows a flow diagram of method steps in accordance with a second embodiment of the present invention.

### BEST MODES FOR CARRYING OUT THE INVENTION

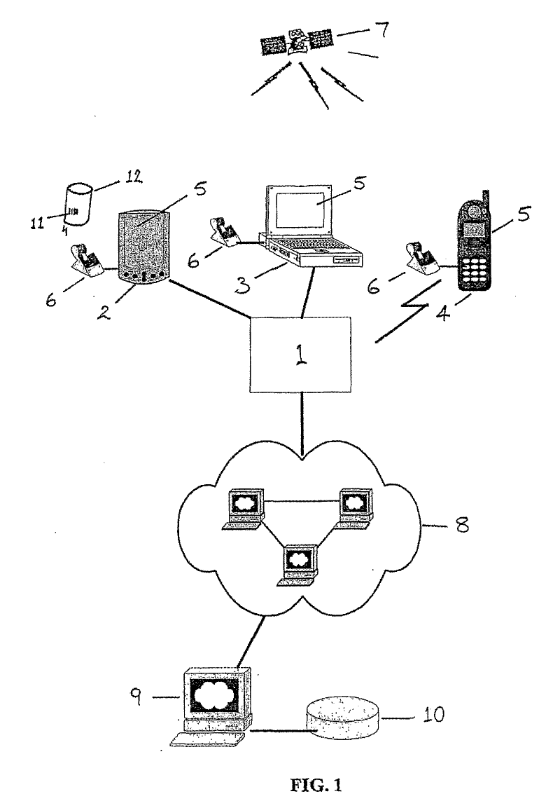

FIG. 1 shows a block diagram of a first embodiment of the present invention including a central server (9) inter-connected with a plurality of second servers (2,3,4) via a communications network (8). The central server (9) includes a mainframe computer which is adapted to process multiple incoming data transfers from the second servers (2,3,4), store the data in a database (10), and process the data so as to generate a series of reports based on the information.

Each of the second servers (2,3,4) are interconnected to the central server (9) via a Virtual Private Network (VPN) (8) or otherwise secure data communication network which allows sales representatives to remotely log in to the central server through a private or public exchange (1). Transaction information which is transmitted between first and second servers may be encrypted in accordance with an encryption protocol.

The central server (9) includes a database management system for storing transaction data received from the remote second servers (2,3,4). For instance, the database (10) may be implemented using any number of suitable commercial hardware and/or software packages.

By way of example, the second servers (2,3,4) include 3 portable computing devices—a Tablet™ PC (2), a cellular mobile phone (4), and a portable laptop computer (3). Each of the second server devices (2,3,4) include a PC card modem adapted to facilitate the transfer of data across the secure data network (8). The second servers (2,3,4) also include GPS adaptor hardware and software to enable interfacing with a common Global Positioning System (GPS) network. In this way, each second server may have a common time reference. Also, the GPS system will also provide each second server with a common positioning system to document various locations where given transactions takes place.

The second servers (2,3,4) each include touch-screen display capability and associated software whereby a signature written across the display surface may be input and processed by the device. Also, the second servers (2,3,4) are each interfaced to an external bar code scanning device (6) and a keypad. The bar-coded scanning device may interfaced with a PDA for instance via a card slot.

The first embodiment also involves applying a bar code (11) to the pharmaceutical products (12) which are to be distributed from pharmaceutical company sales representatives to medical practitioners. The bar codes (11) represent, in standard encoded format, information relating, amongst other things, the following:
the name of the pharmaceutical product;
the batch number of the product;
the therapeutic class and schedule of the drug/product.

The details contained in the bar code are also printed on the product packaging in human-readable indicia. Thus, this information relating to the nature and identity of the product is able to be either scanned into the second server using a bar-coded scanner interfaced with the second server, or alternatively, is able to be manually entered into the second server via a keypad if required.

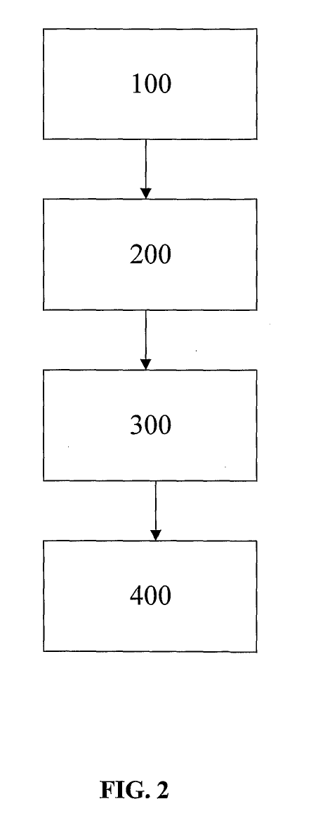

Thus, in use, the second servers (2,3,4) are adapted to generate a transaction data package representing details surrounding the exchange of, for instance, drug samples from the sales representative to the medical practitioner. The transaction data package is generated by reference to a combination of inputs received via a combination of the touch-screen keypad (5), the bar-code scanner (6), and, the GPS network interface. The step of inputting transaction information into the second server is indicated at (100) in the flow-diagram of FIG. 2. The information contained in the generated data package includes the following:
(a) data representing the identity of the medical practitioner receiving the product/item;
(b) data representing the identity of the sales representative supplying the product/item;
(c) data representing the identity and a schedule of the product/item being distributed;
(d) data representing the quantity of the product/item being distributed;
(e) data representing the time and date at which the product/item is distributed;
(f) data representing the location where the distribution takes place;
(g) data representing an expiry date of the product/item being distributed;
(h) data representing a batch number of the product/item being distributed.

The second servers (2,3,4) include processing software programmed to assist in automating the above data input step. When the program is run, the second servers (2,3,4) are adapted to perform the following steps:
(a) a timestamp is generated for the drug sample transaction by reference to a GPS system clock to which the second server is interfaced. The processing software is also configured to periodically (eg. at intervals of 5 seconds) synchronise the second server internal clock with the GPS clock;
(b) a set of position coordinates are generated relating to the location of the drug sample transaction by reference to the GPS navigation system;
(c) information relating to the batch number, name, and quantity, amongst other things of a drug sample being distributed during a transaction are entered manually into the second server via the keypad, or, the same type of information is entered into the second server using a bar-code scanner;
(d) reading and storing in electronic format, a signature of the receiving party (e.g. a medical practitioner) that has been entered via the touch-screen display;
(e) a unique identifier is added to the data package which identifies the sales representative who is involved in the drug sample distribution;
(f) signature verification of the hand-written signature imprinted on the touch screen display by the medical practitioner.

Once, generated, the transaction data package is encrypted and then transmitted to the first server (9) via the secure data network (8) where it is received and stored in the mainframe database (10). These steps of transmitting and storing the transaction data are indicated at (200) and (300) respectively in the flow-diagram of FIG. 2. In the first embodiment, each second server (2,3,4) will transmit transaction data packages in real-time so that information compiled into the central server is able to be manipulated and processed whereby relevant reports regarding drug distribution and other activity is able to be generated in a timely and commercially relevant fashion.

The central server (9) also includes processing software to perform, amongst other things, generating reports by reference to the stored transaction data received from each second server (2,3,4).

The contents of the database (10) may be queried using a query language interface. For instance, a company manager responsible for supervising the activities of sales representatives within a pharmaceutical company may desire to analyse the performance of a particular sales representative operating over a given time period. By using the query language program to query the stored transaction data in the mainframe database, a report may be relatively easily generated for all activity which for instance summarises the work patterns and productivity of an individual or group of sales representatives. Alternatively, the report may contain information regarding the demand for certain types of drug products within a particular geographic region. This step is shown at (400) in the flow-diagram of FIG. 2.

By way of example only, a typical report that is generated (eg. a “Daily Report”) based on transaction information stored in the database, may include a table listing a number of medical practitioners that the sales representative may have visited on a particular day as well as the name, quantity and batch number of products/items distributed to each doctor. The report may also provide details relating to the date and time of each visit to the doctors as well as verification of the Doctor's signature.

Alternatively, the central server software may be automated to periodically generate a report in adherence with government regulatory requirements and to transmit the report to the relevant government authority.

Alternatively, the central server software may be adapted to automate a product recall. For instance, the software may be able to search the database (10) contents for information relating to all medical practitioners which may have received a recalled drug sample over a certain time period, and automatically generate and send a notification to the relevant medical practitioners requesting the return of the product in question. The notification is able to be generated via E-mail, SMS or any other suitable communication protocol and transmitted accordingly from the central server to the Medical Practitioners across an existing communications infrastructure.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

1. A method for use in tracking the transaction of pharmaceutical-related products from a supplier to a receiver, said method being operable on a computer system including a first server interconnected to a relatively remote second server via a communication link, wherein said method includes the steps of:
(i) inputting transaction information into the second server, said transaction information including electronically encoded data representing a unique signature of the receiver for verifying the identity of the receiver;
(ii) transmitting the transaction information from the second server to the first server via the communication link;
(iii) storing the transaction information received by the first server in a database of the first server;
(iv) generating a report based on the transaction information stored in the database.

2. A method as claimed in claim 1 wherein the supplier includes a sales representative of a pharmaceutical company.

3. A method as claimed in claim 1 wherein the receiver includes at least one of:
(a) a medical practitioner; and
(b) a pharmacist.

4. A method as claimed in any claim 1 including the step of interconnecting the first sever with a plurality of second servers via the communication link.

5. A method as claimed in claim 4 wherein the communication link includes at least one of:
(a) the Internet;
(b) a Wide-Area-Network;
(c) a Local-Area-Network.

6. A method as claimed in any claim 1 including the step of implementing a security protocol across the communication link.

7. A method as claimed in claim 6 wherein the security protocol includes a data encryption protocol for encrypting/decrypting data communicated between the first server and the plurality of second servers.

8. A method as claimed in any claim 1 including the step of providing a database for storing transaction information.

9. A method as claimed in claim 8 wherein the database is interfaced with the first server.

10. A method as claimed in claim 1 wherein the second server includes at least one of:
(a) a PDA;
(b) a portable computer; and
(c) a mobile phone.

11. A method as claimed in claim 1 wherein the transaction information includes at least one of the following details of the transaction:
(a) data representing an identity of the receiver;
(b) data representing an identity of the supplier;
(c) data representing an identity of the product being distributed;
(d) data representing a quantity of the product being distributed;
(e) data representing a time and/or date at which the product is distributed;
(f) data representing a location where the distribution takes place;
(g) data representing an expiry date of the product being distributed;
(h) data representing a batch number of the product being distributed.

12. A method as claimed in claim 1 wherein the signature of the receiver includes at least one of:
(a) a hand-written signature encoded in electronic format;
(b) a unique code and/or password; and
(c) a unique biometric characteristic.

13. A method as claimed in claim 1 including the step of inputting transaction information into the second server includes the use of at least one of:
(a) a keypad;
(b) a scanner such as a bar-code scanner; and
(c) a touch-screen display.

14. A method as claimed in claim 1 wherein at least some of the transaction information is encoded in bar-code format whereby it can be scanned in to the second server by a bar-code scanner.

15. A method as claimed in claim 1 wherein transaction information relating to a time and/or date of a transaction is provided in the form of a timestamp.

16. A method as claimed in claim 15 wherein the time stamp is generated by reference to a GPS network clock.

17. A method as claimed in claim 16 wherein a clock of the second server is synchronised with the GPS network clock.

18. A method as claimed in claim 1 wherein transaction information relating to a location of the transaction is generated by reference to a GPS network navigation system.

19. A method as claimed in claim 16 including the step of interfacing the second server with the GPS network.

20. A method as claimed in claim 1 wherein the step of transmitting the transaction information from the second server to the first server is carried out using at least one of the following communication methods:
(a) E-mail;
(b) facsimile;
(c) Short-Message-Service;
(d) GPRS.

21. A method as claimed in claim 1 including the step of verifying the authenticity of the received signature data.

22. A method as claimed in claim 21 including the step of performing a correlation of the received signature with a pre-recorded sample of the receiver's signature.

23. A method as claimed in claim 22 wherein the step of correlating the received signature with a pre-recorded sample is automatically performed by a computer program.

24. A method as claimed in claim 21 including the step of generating a notification where a signature is unsuccessfully verified.

25. A method as claimed in claims claim 1 wherein the step of generating a report is performed automatically on a predetermined periodic basis.

26. A method as claimed in claim 1 including the step of automatically communicating the report to a third party.

27. A method as claimed in claim 26 wherein the step of communicating the report to a third party includes the use of at least one of:
(a) E-mail;
(b) Facsimile;
(c) Short-Message-Service;
(d) Printed message utilising conventional mailing system;
(e) GPRS; or
(f) a Web page accessible via the Internet.

28. A method as claimed in claim 27 wherein the Web page includes a secured Web page.

29. A method as claimed in claim 1 wherein the step of transmitting information from the second server to the first server is effected substantially in real-time.

30. A computerised system programmed to perform the method steps in accordance with claim 1.

31. A computer-readable medium having computer-executable instructions for performing the method steps in accordance with claim 1.

32. A computer-readable medium having stored thereon a data structure produced in accordance with the method steps of claim 1.

33. In combination with a computer system, a graphical-user interface including a display and a selection device, a method of providing and selecting from a menu on the display, the method steps of claim 1.

34. A report generated in accordance with the method steps of claim 1.
